(19) United States
(12) Patent Application Publication
(10) Pub. No.: US 2007/0016378 A1
(43) Pub. Date: Jan. 18, 2007

(54) Method and system for affinity analysis

(75) Inventor: Karl Andersson, Uppsala (SE)

Correspondence Address: SEED INTELLECTUAL PROPERTY LAW GROUP PLLC, 701 FIFTH AVE, SUITE 5400, SEATTLE, WA, 98104, US

(73) Assignee: Biacore AB, Uppsala (SE)

(21) Appl. No.: 11/452,102

(22) Filed: Jun. 12, 2006

Related U.S. Application Data
(60) Provisional application No. 60/689,819, filed on Jun. 13, 2005.

(30) Foreign Application Priority Data
Jun. 13, 2005 (SE) 0501335-4

(51) Int. Cl. G06F 19/00; G06G 7/48

(52) U.S. Cl. 702/19; 703/11

(57) ABSTRACT

A method of determining affinity for a molecular binding interaction from measured steady state binding data comprises the steps of: a) providing a plurality of experimental binding data sets for the binding interaction between two chemical species, wherein each data set includes binding data measured at multiple time points during an association phase and a dissociation phase of the interaction, b) selecting from the plurality of experimental binding data sets a plurality of binding data measured at a defined time point at or near the end of the association phase as representing steady state binding data, c) subjecting each data set to a quality control which comprises estimating the reliability of the steady state binding data by evaluating other binding data of the same data set, d) excluding each data set which is estimated in step c) to contain unreliable steady state binding data, and e) determining the affinity from the steady state binding data of remaining data sets.

### CROSS-REFERENCE TO RELATED APPLICATION

This application claims the benefit under 35 U.S.C. § 119(e) of U.S. Provisional Patent Application No. 60/689,819 filed Jun. 13, 2005; and also claims priority to Swedish Application No. 0501335-4 filed Jun. 13, 2005; both of these applications are incorporated herein by reference in their entireties.

### BACKGROUND OF THE INVENTION

1. Field of the Invention

The present invention relates to a method of analysing molecular binding interactions at a sensing surface, and more particularly to a method of determining the affinity for the interactions based on steady state binding data and which permits an at least partially automated procedure. The invention also relates to an analytical system including means for such automated affinity evaluations as well as to a computer program for performing the method, a computer program product comprising program code means for performing the method, and a computer system containing the program.

2. Description of the Related Art

Analytical sensor systems that can monitor interactions between molecules, such as biomolecules, in real time are gaining increasing interest. These systems are often based on optical biosensors and usually referred to as interaction analysis sensors or biospecific interaction analysis sensors. A representative such biosensor system is the BIACORE® instrumentation sold by Biacore AB (Uppsala, Sweden) which uses surface plasmon resonance (SPR) for detecting interactions between molecules in a sample and molecular structures immobilized on a sensing surface. As sample is passed over the sensor surface, the progress of binding directly reflects the rate at which the interaction occurs. Injection of sample is followed by a buffer flow during which the detector response reflects the rate of dissociation of the complex on the surface. A typical output from the BIACORE® system is a graph or curve describing the progress of the molecular interaction with time, including an association phase part and a dissociation phase part. This binding curve, which is usually displayed on a computer screen, is often referred to as a “sensorgram”.

With the BIACORE® system (and analogous sensor systems), it is thus possible to determine in real time without the use of labeling, and often without purification of the substances involved, not only the presence and concentration of a particular molecule (analyte) in a sample, but also additional interaction parameters, including kinetic rate constants for binding (association) and dissociation in the molecular interaction as well as the affinity for the surface interaction. The association rate constant (kₐ) and the dissociation rate constant (k_{d}) can be obtained by fitting the resulting kinetic data for a number of different sample analyte concentrations to mathematical descriptions of interaction models in the form of differential equations. The affinity (expressed as the affinity constant K_{A} or the dissociation constant K_{D}) can be calculated from the association and dissociation rate constants. Many times, however, it may be difficult to obtain definitive kinetic data, and it is therefore usually more reliable to measure the affinity by equilibrium binding analysis, which involves determining, for a series of analyte concentrations, the level of binding at equilibrium, or steady state, which is presumed to have been reached at or near the end of the association phase of the binding interaction. To ensure that the association phase of the binding curve is indeed likely to have reached steady state, one usually determines in advance the necessary time length of sample injection (i.e., sample contact time with the sensor chip surface) for the bound analyte to reach equilibrium under the conditions intended to be used for the affinity measurements. Since both the time taken to reach equilibrium and the time it takes for the anlyte to dissociate are governed primarily by the dissociation rate constant, approximate injection times may also be estimated from the dissociation constant.

Prior to evaluating the sensorgrams with regard to kinetics and/or affinity, a quality control is usually performed by the operator to discard sensorgrams which are of unacceptable quality due to instrument-related faults, such as, e.g., air spikes caused by air bubbles in the fluid flow.

While the evaluation of kinetic and affinity data obtained by the BIACORE® and similar instruments is usually assisted by dedicated software, intervention by the operator has, however, usually been required during the iterative curve fitting process to inter alia identify and exclude binding curves that give rise to a bad fit, for example, due to assay-related faults, such as, for example, the presence of particles in a sample.

The current trend towards systems with ever increasing throughput and information density in the analyses performed, putting a more and more heavy burden on the operator, has urged the development of automated procedures for the control of binding curve quality, such as disclosed in, e.g., WO 03/081245, as well as for the evaluation of kinetic data, such as disclosed in, e.g., WO 2005/029077.

There is, however, still a need for a similar automated procedure for the evaluation of steady state affinity data, especially where large sets of interaction data, such as sensorgrams, are produced. A crucial problem to overcome in this context is to ensure that the binding curves obtained have at least substantially reached equilibrium before the binding level is read.

### BRIEF SUMMARY OF THE INVENTION

It is an object of the present invention to provide a method for determining the affinity for a molecular binding interaction from steady state binding level data, which method can be at least partially automated. Another object of the invention is to provide a method for determining the affinity for a molecular binding interaction from steady state binding level data, which method may automatically exclude unreliable steady state binding level data. These and other objects and advantages are achieved by a method based on the finding that other interaction data than steady state binding data from a data set (usually a binding curve) may be used to estimate or determine if the steady state binding data of the data set is reliable. Expressed otherwise, data from one domain of a binding curve (e.g., the dissociation phase) may be used to determine if it is meaningful to evaluate data from another domain of the same binding curve (e.g., steady state).

In one aspect, the present invention therefore provides a method of determining affinity for a molecular binding interaction from measured steady state binding data, which method comprises the steps of:

a) providing a plurality of experimental binding data sets for the binding interaction between two chemical (including biochemical) species, wherein each data set contains binding data measured at multiple time points during an association phase and a dissociation phase of the interaction,

b) selecting from the plurality of experimental binding data sets a plurality of binding data measured at a defined time point at or near the end of the association phase as representing steady state binding data,

c) subjecting each data set to a quality control which comprises estimating the reliability of the steady state binding data by evaluating other binding data of the same data set,

d) excluding each data set which is estimated in step c) to contain unreliable steady state binding data, and

e) determining the affinity from the steady state binding data of remaining data sets.

In one embodiment of this aspect, steps c) to e) comprise the following steps:

selecting pluralities of other binding data from the plurality of experimental binding data sets;

determining which ones of the pluralities of other binding data fall within a pre-determined range, the pre-determined range representing the quality of the ones of the experimental binding data sets;

excluding from the final plurality of experimental binding data sets poor-quality experimental binding data sets, whereby the poor-quality experimental binding data sets have pluralities of other binding data falling outside of the predetermined range; and

determining the affinity from the steady state binding data from the final plurality of experimental binding data sets.

In another aspect, the present invention provides an analytical system for studying molecular interactions, which comprises data processing means for performing the above method.

In still another aspect, the present invention provides a computer program comprising program code means for performing the method.

In yet another aspect, the present invention provides a computer program product comprising program code means stored on a computer readable medium or carried on an electrical or optical signal for performing the method.

In still another aspect, the present invention provides a computer system containing a computer program comprising program code means for performing the method.

A more complete understanding of the present invention, as well as further features and advantages thereof, will be obtained by reference to the following detailed description and drawings.

### BRIEF DESCRIPTION OF THE DRAWINGS

FIG. 1 is a schematic side view of a biosensor system based on SPR.

FIG. 2 is a representative sensorgram where the binding curve has visible association and dissociation phases.

FIG. 3 shows twelve different diagrams where the curve fitting error for affinity is plotted in a log(dissociation rate constant) versus log(association rate constant) map at different sample injection time lengths.

FIG. 4 is a flow chart of an embodiment of affinity determination according to the present invention.

### DETAILED DESCRIPTION OF THE INVENTION

Unless defined otherwise, all technical and scientific terms used herein have the same meaning as commonly understood by a person skilled in the art related to this invention. Also, the singular forms “a”, “an”, and “the” are meant to include plural reference unless it is stated otherwise.

All publications, patent applications, patents, and other references mentioned herein are incorporated by reference in their entirety.

As mentioned above, the present invention relates to the evaluation of steady state binding data for a molecular binding interaction from a plurality of data sets for the interaction to determine the affinity for the interaction, wherein other interaction data from a data set than steady state binding data is used to estimate the reliability of the steady state binding data of the data set. Typically, the experimental binding data is obtained by sensor based technology which studies the molecular interactions and present the results in real time as the interactions progress. Before describing the present invention in more detail, however, the general context in which the invention is intended to be used will be described.

Chemical sensors or biosensors are typically based on label-free techniques, detecting a change in a property of a sensor surface, such as, e.g., mass, refractive index, or thickness for the immobilized layer, but there are also sensors relying on some kind of labelling. Typical sensor detection techniques include, but are not limited to, mass detection methods, such as optical, thermo-optical and piezoelectric or acoustic wave methods (including, e.g., surface acoustic wave (SAW) and quartz crystal microbalance (QCM) methods), and electrochemical methods, such as potentiometric, conductometric, amperometric and capacitance/impedance methods. With regard to optical detection methods, representative methods include those that detect mass surface concentration, such as reflection-optical methods, including both external and internal reflection methods, which are angle, wavelength, polarization, or phase resolved, for example evanescent wave ellipsometry and evanescent wave spectroscopy (EWS, or Internal Reflection Spectroscopy), both of which may include evanescent field enhancement via surface plasmon resonance (SPR), Brewster angle refractometry, critical angle refractometry, frustrated total reflection (FTR), scattered total internal reflection (STIR) (which may include scatter enhancing labels), optical wave guide sensors; external reflection imaging, evanescent wave-based imaging such as critical angle resolved imaging, Brewster angle resolved imaging, SPR-angle resolved imaging, and the like. Further, photometric and imaging/microscopy methods, “per se” or combined with reflection methods, based on for example surface enhanced Raman spectroscopy (SERS), surface enhanced resonance Raman spectroscopy (SERRS), evanescent wave fluorescence (TIRF) and phosphorescence may be mentioned, as well as waveguide interferometers, waveguide leaky mode spectroscopy, reflective interference spectroscopy (RIfS), transmission interferometry, holographic spectroscopy, and atomic force microscopy (AFR).

Commercially available biosensors include the afore-mentioned BIACORE® system instruments, manufactured and marketed by Biacore AB, Uppsala, Sweden, which are based on surface plasmon resonance (SPR) and permit monitoring of surface binding interactions in real time between a bound ligand and an analyte of interest. In this context, “ligand” is a molecule that has a known or unknown affinity for a given analyte and includes any capturing or catching agent immobilized on the surface, whereas “analyte” includes any specific binding partner thereto.

While in the detailed description and Examples that follow, the present invention is illustrated in the context of SPR spectroscopy, and more particularly the BIACORE® system, it is to be understood that the present invention is not limited to this detection method. Rather, any affinity-based detection method where an analyte binds to a ligand immobilized on a sensing surface may be employed, provided that a change at the sensing surface can be measured which is quantitatively indicative of binding of the analyte to the immobilized ligand thereon.

The phenomenon of SPR is well known; suffice it to say that SPR arises when light is reflected under certain conditions at the interface between two media of different refractive indices, and the interface is coated by a metal film, typically silver or gold. In the BIACORE® instruments, the media are the sample and the glass of a sensor chip which is contacted with the sample by a microfluidic flow system. The metal film is a thin layer of gold on the chip surface. SPR causes a reduction in the intensity of the reflected light at a specific angle of reflection. This angle of minimum reflected light intensity varies with the refractive index close to the surface on the side opposite from the reflected light, in the BIACORE® system the sample side.

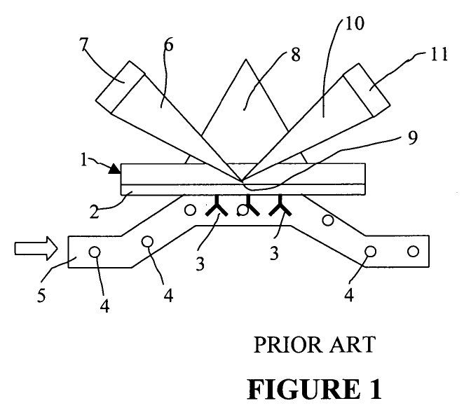

A schematic illustration of the BIACORE® system is shown in FIG. 1. Sensor chip 1 has a gold film 2 supporting capturing molecules (ligands) 3, e.g., antibodies, exposed to a sample flow with analytes 4, e.g., an antigen, through a flow channel 5. Monochromatic p-polarized light 6 from a light source 7 (LED) is coupled by a prism 8 to the glass/metal interface 9 where the light is totally reflected. The intensity of the reflected light beam 10 is detected by an optical detection unit 11 (photodetector array).

A detailed discussion of the technical aspects of the BIACORE® instruments and the phenomenon of SPR may be found in U.S. Pat. No. 5,313,264. More detailed information on matrix coatings for biosensor sensing surfaces is given in, for example, U.S. Pat. Nos. 5,242,828 and 5,436,161. In addition, a detailed discussion of the technical aspects of the biosensor chips used in connection with the BIACORE® instruments may be found in U.S. Pat. No. 5,492,840.

When molecules in the sample bind to the capturing molecules on the sensor chip surface, the concentration, and therefore the refractive index at the surface changes and an SPR response is detected. Plotting the response against time during the course of an interaction will provide a quantitative measure of the progress of the interaction. Such a plot, or kinetic or binding curve (binding isotherm), is usually called a sensorgram, also sometimes referred to in the art as “affinity trace” or “affinogram”. In the BIACORE® system, the SPR response values are expressed in resonance units (RU). One RU represents a change of 0.0001° in the angle of minimum reflected light intensity, which for most proteins and other biomolecules correspond to a change in concentration of about 1 pg/mm² on the sensor surface. As sample containing an analyte contacts the sensor surface, the capturing molecule (ligand) bound to the sensor surface interacts with the analyte in a step referred to as “association.” This step is indicated on the sensorgram by an increase in RU as the sample is initially brought into contact with the sensor surface. Conversely, “dissociation” normally occurs when the sample flow is replaced by, for example, a buffer flow. This step is indicated on the sensorgram by a drop in RU over time as analyte dissociates from the surface-bound ligand.

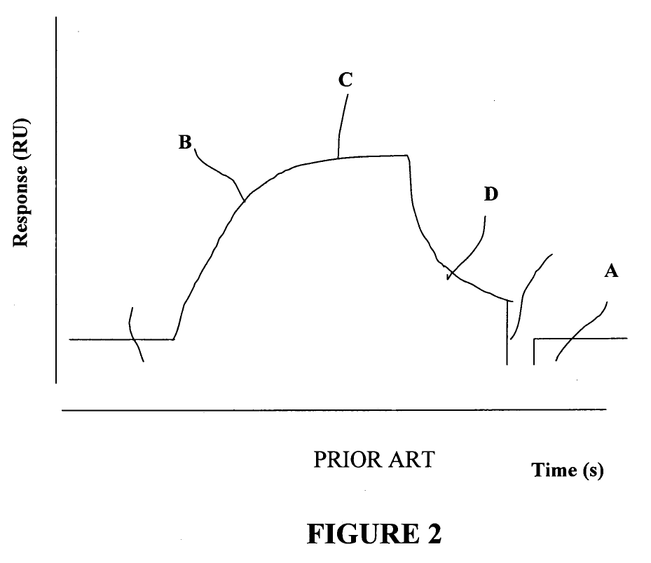

A representative sensorgram (binding curve) for a reversible interaction at the sensor chip surface is presented in FIG. 2, the sensing surface having an immobilized capturing molecule, or ligand, for example an antibody, interacting with a binding partner therefor, or analyte, in a sample. The binding curves produced by biosensor systems based on other detection principles mentioned above will have a similar appearance. The vertical axis (y-axis) indicates the response (here in resonance units, RU) and the horizontal axis (x-axis) indicates the time (here in seconds). Initially, buffer is passed over the sensing surface giving the baseline response A in the sensorgram. During sample injection, an increase in signal is observed due to binding of the analyte. This part B of the binding curve is usually referred to as the “association phase”. Eventually, a steady state condition is reached at or near the end of the association phase where the resonance signal plateaus at C (this state may, however, not always be achieved). It is to be noted that herein the term “steady state” is used synonymously with the term “equilibrium” (in other contexts the term “equilibrium” may be reserved to describe the ideal interaction model, since in practice binding could be constant over time even if a system is not in equilibrium). At the end of sample injection, the sample is replaced with a continuous flow of buffer and a decrease in signal reflects the dissociation, or release, of analyte from the surface. This part D of the binding curve is usually referred to as the “dissociation phase”. The analysis is ended by a regeneration step where a solution capable of removing bound analyte from the surface, while (ideally) maintaining the activity of the ligand, is injected over the sensor surface. This is indicated in part E of the sensorgram. Injection of buffer restores the baseline A and the surface is now ready for a new analysis.

From the profiles of the association and dissociation phases B and D, respectively, information regarding the binding and dissociation kinetics is obtained, and the height of the resonance signal at C represents affinity (the response resulting from an interaction being related to the change in mass concentration on the surface). This will now be explained in more detail below.

Surface Binding Rate

Assume a reversible reaction between an analyte A and a surface-bound (immobilized) capturing molecule, or ligand, B which is not diffusion or mass transfer limited and obeys pseudo first order kinetics:
A+B [symbol] AB
This interaction model (usually referred to as the Langmuir model), which assumes that the analyte (A) is both monovalent and homogenous, that the ligand (B) is homogenous, and that all binding events are independent, is in fact applicable in the vast majority of cases.

The rate of change in surface concentration of analyte A (=rate of change in concentration of formed complex AB) during analyte injection is the sum of the rates of the analyte A going on and off:

$$\frac{ⅆ [ AB ]}{ⅆ t} = {k}_{a} [ A ] [ B ] - {k}_{d} [ AB ] \qquad ( 1 )$$

where [A] is the concentration of analyte A, [B] is the concentration of the ligand B, [AB] is the concentration of the reaction complex AB, kₐ is the association rate constant, and k_{d} is the dissociation rate constant.

After a time t, the concentration of unbound ligand B at the surface is [B_{T}]−[AB], where [B_{T}] is the total, or maximum, concentration of ligand B. Insertion into Equation (1) gives:

$$\frac{ⅆ [ AB ]}{ⅆ t} = {k}_{a} [ A ] \{ [ {B}_{T} ] - [ AB ] \} - {k}_{d} [ AB ] \qquad ( 2 )$$

In terms of detector response units (AB is detected), this can be expressed as

$$\frac{ⅆ R}{ⅆ t} = {k}_{a} C ( {R}_{max} - R ) - {k}_{d} R \qquad ( 3 )$$

where R is the response at time t in resonance units (RU), C is the initial, or bulk, concentration of free analyte (A) in solution, and Rₘₐₓ is the response (in RU) obtained if analyte (A) had bound to all ligand (B) on the surface. Rearrangement of Equation (3) gives:

$$\frac{ⅆ R}{ⅆ t} = {k}_{a} {CR}_{max} - ( {k}_{a} C + {k}_{d} ) R \qquad ( 4 )$$

where R is the response in resonance units (RU). In integrated form, the equation is:

$$R = \frac{{k}_{a} {CR}_{max}}{{k}_{a} C + {k}_{d}} ( 1 - {ⅇ}^{- ( {k}_{a} C + {k}_{d} ) t} ) \qquad ( 5 )$$

Calculation of kₐ and k_{d}

Now, according to equation (4), if dR/dt is plotted against the bound analyte concentration R, the slope is −(kₐC+k_{d}) and the vertical intercept is kₐRₘₐₓC. If the bulk concentration C is known and Rₘₐₓ has been determined (e.g., by saturating the surface with a large excess of analyte), the association rate constant kₐ and the dissociation rate constant k_{d} can be calculated. A more convenient method is, however, fitting of the integrated function (5), or numerical calculation and fitting of the differential Equation (4), preferably by means of a computer program.

k_{d} may also be determined in the following way. The rate of dissociation can be expressed as:

$$\frac{ⅆ R}{ⅆ t} = - {k}_{d} R \qquad ( 6 )$$

and in integrated form:
R=R₀·e^{-k}^{_{d}}^{t} (7)
where R₀ is the response at the beginning of the dissociation phase (when the buffer wash of the surface starts).

Equation (6) may be linearized:

$$ln [ \frac{R}{{R}_{0}} ] = - {k}_{d} t \qquad ( 8 )$$

and a plot of 1n[R/R₀] versus t will produce a straight line with the slope=−k_{d}. More conveniently, however, the dissociation rate constant k_{d} is determined by fitting the exponential rate equation (7).

To obtain reliable kinetic constants, the above described analysis is usually repeated for a numbr of different analyte concentrations and, suitably, also at at least one other ligand density at the sensor surface.

Calculation of Affinity

Affinity is expressed by the association constant K_{A}=kₐ/k_{d}, or the dissociation constant (also referred to as the equilibrium constant) K_{D}=k_{d}/kₐ.

The association constant K_{A} may alternatively be determined from Equation (3), where dR/dt=0 at equilibrium, giving:
k_{d}R_{eq}=kₐC(Rₘₐₓ−R_{eq}) (9)
where R_{eq} is the detector response at equilibrium. Since kₐ/k_{d}=K_{A}, insertion in Equation (9) and rearrangement gives:

$$\frac{{R}_{eq}}{C} = - {K}_{A} {R}_{eq} + {K}_{A} {R}_{max} \qquad ( 10 )$$

If binding reactions are performed at multiple concentrations, K_{A} may be obtained by non-linear curve-fitting of the data. Alternatively, e.g., when the kinetic data is unreliable or association and dissociation are too rapid to measure accurately, R_{eq}/C may be plotted versus R_{eq}, which gives the slope=−K_{A} (Scatchard plot).

Rearrangement of Equation (10) gives:

$${R}_{eq} = \frac{{K}_{A} {CR}_{max}}{1 + {K}_{A} C} \qquad ( 11 )$$

Insertion of K_{A}=1/K_{D} into Equation (11) gives:

$${R}_{eq} = \frac{{CR}_{max}}{{K}_{D} + C} \qquad ( 12 )$$

Usually, Equation (12) is modified to:

$${R}_{eq} = \frac{{CR}_{max}}{{K}_{D} + C} + Offset \qquad ( 13 )$$

where “Offset” is a compensation factor for parallel baseline displacement due to systemic refractive index errors.

Equations (11) and (12) may be modified by introducing a steric interference factor n specifying how many binding sites are on average blocked by one analyte molecule:

$$\begin{matrix}{R}_{eq} = \frac{{K}_{A} {CR}_{max}}{1 + {K}_{A} Cn} & ( 14 ) \\ {R}_{eq} = \frac{{CR}_{max}}{{K}_{D} + Cn} & ( 15 )\end{matrix}$$

Software-Assisted Analysis

Software for the analysis of kinetic and affinity data is commercially available. Thus, for example, evaluation of kinetic and affinity data produced by the BIACORE® instruments is usually performed with the dedicated BlAevaluation software (supplied by Biacore AB, Uppsala, Sweden) using numerical integration to calculate the differential rate equations and non-linear regression to fit the kinetic and affinity parameters by finding values for the variables that give the closest fit, reducing the sum of squared residuals to a minimum. The “residuals” are the difference between the calculated and the experimental curve at each point, squared residuals being used to weight equally deviations above and below the experimental curve. The sum of squared residual is expressed by Equation (16):

$$S = {\sum }_{1}^{n} {( {r}_{f} - {r}_{x} )}^{2} \qquad ( 16 )$$

where S is the sum of squared residuals, r_{f} is the fitted value at a given point, and rₓ is the experimental value at the same point.

For example, for the molecular interaction described above, such software-assisted data analysis is performed by, after subtracting background noises, making an attempt to fit the above-mentioned simple 1:1 Langmuir binding model as expressed by Equations (5) and (7) above to the measurement data.

Usually the binding model is fitted simultaneously to multiple binding curves obtained with different analyte concentrations C (and/or with different levels of surface derivatization Rₘₐₓ). This is referred to as “global fitting”, and based on the sensorgram data such global fitting establishes whether a single global kₐ or k_{d} will provide a good fit to all the data. The results of the completed fit is presented to the operator graphically, displaying the fitted curves overlaid on the original sensorgram curves. The closeness of the fit is also presented by the chi-squared (χ²) value, below referred to as “chi2”, a standard statistical measure. For a good fitting, the chi2 value is in the same magnitude as the noise in RU². Optionally, “residual plots” are also provided which give a graphical indication of how the experimental data deviate from the fitted curve showing the difference between the experimental and fitted data for each curve. The operator then decides if the fit is good enough. If not, the sensorgram or sensorgrams exhibiting the poorest fit are excluded and the fitting procedure is run again with the reduced set of sensorgrams. This procedure is repeated until the fit is satisfactory.

Determining affinity constants from measured steady state binding levels with the BIAevaluation software involves the following steps:

(i) obtain steady state binding levels (R_{eq}) from report points on the sensorgrams in the steady state region of the curve;

(ii) create a plot of R_{eq} against C; and

(iii) fit this plot to a general “Steady state affinity” fitting model (e.g., Equation (13 or 14) to obtain K_{A}/K_{D} and Rₘₐₓ.

The Invention

As mentioned above, the present invention relates to a method for determining the affinity (K_{A} or K_{D}) for a molecular binding interaction from multiple steady state binding data measured for the interaction, which method is amenable to automation, thereby permitting sets of experimental binding data for a plurality of different interactions to be collected and the respective affinities for the different analytes to be determined with minimum labour to the operator. The term “data set” as used herein refers to the data representing a binding curve, such as a sensorgram. A “batch” of data sets, as the term is used herein, comprises two or more data sets.

A prerequisite for such an automated affinity evaluation procedure is the automatic exclusion of steady state data which is unreliable, meaning, for instance, either that the binding interaction has not essentially reached equilibrium when the binding level data is read, or that the steady state part of the binding curve is defective in some other respect.

The steady state binding data is usually read at a report point at or near the end of the association phase. Such a “report point” is in fact a short time window, typically about five seconds, over which the detected response values are averaged. To determine if equilibrium has substantially been reached at that stage of the binding curve, it would seem sufficient to study the slope of this binding curve region (which should be planar at equilibrium). However, due to the short report point window, detection noise will usually cause even equilibrated binding curves to have sloping report points. Increasing the report point window will not remedy the situation to any appreciable extent.

According to the invention, the reliability of the steady state data of a binding curve is estimated based on binding data taken from other parts, or domains, of the binding curve. From such binding data different “reliability indicators” may be estimated.

A first such reliability indicator is the dissociation rate, which may be used to determine if it is likely that the interaction has approached equilibrium or not in the association phase at the experimental conditions used. (For equilibrium to be considered to have substantially been reached, the slope of the curve in the steady state detection window is typically less than about 1% per second, preferably less than about 1% per second (about 0.03 RU/s for Rₘₐₓ of about 30 RU).) Thus, if the dissociation rate is too slow, the time that the sample contacts the sensing surface may not be sufficient time for equilibrium to be reached. More specifically, for the BIACORE® and similar systems where the sample passes the sensing surface in a fluid flow, it has been found that for each sample injection time length (i.e., the time that sample is in contact with the sensing surface), there is a dissociation rate limit (which is substantially independent on the association rate) below which it is not possible to reliably calculate the affinity (K_{A} or K_{D}) in steady state analysis. This dissociation rate limit may advantageously be determined empirically, such as by actual tests or by computer simulation as described below.

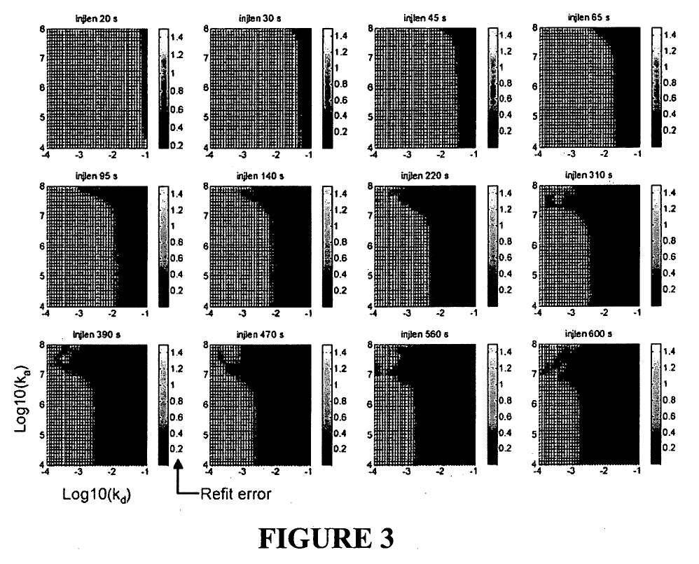

FIG. 3 shows twelve different diagrams (plots) where the curve fitting error for affinity has been plotted in a log(dissociation rate) versus log(association rate) map at different injection lengths. These diagrams were obtained in MATLAB™ 6.5 (The MathWorks, Inc., Natick, Mass., U.S.A.) by: (1) simulating (using Equation 5 above and random noise) concentration series of sensorgrams for about kₐ=10⁴ to 10⁸ and k_{d}=10⁻¹ to 10⁻⁴ at different Rₘₐₓ; (2) taking a report point from each sensorgram; (3) fitting the report point values to a steady state affinity model (Equation 12 above and nonlinear regression); and (4) plotting the curve fitting error for affinity in a kₐ−k_{d} map. This procedure was repeated for twelve different injection lengths.

In each plot, the dark area to the right indicates a relatively small error in fitted K_{D}, while the light area to the left indicates a relatively large error in fitted K_{D}, a relatively thin grey border region separating the two areas. To the right of each plot there is a greyscale for the refit error ranging from 0 (black) to 1.4 (light). “injlen 20 s” etc above each plot indicates the respective injection length.

As can be seen from the plots, there is for each injection length a dissociation rate which is a limit for when K_{D} may calculated or not. As can also be seen from the plots, this is not quite true for high association rates, noting, however, that the simulations were made with a 1:1 model without mass transport limitation. It is readily seen that with mass transport limitation, the time required to reach equilibrium will be prolonged for high association rates.

Based on the empirical values of the different plots, a mathematical expression (specifically a polynomial) may calculate minimum dissociation rates for different KD's.

Binding data to determine the dissociation rate is usually taken from the dissociation phase but may also be taken from the association phase, or from both domains of the binding curve. To provide for automatic exclusion (by software) of sensorgrams which are likely not to have reached equilibrium, an injection length-dependent dissociation rate limit is set, and the sensorgram(s) in which the estimated dissociation rate is below the set value for the injection length used may automatically be excluded from the data sets to be used for calculating the affinity.

A second reliability indicator that basically may be determined from a domain on the binding curve that is different from the report point window is the last part of the sensorgram, such as, e.g., the last 30 seconds of the association phase. If this curve part (which includes the report point window) has a downward (negative) slope, this is an indicator that something is wrong and that such a sensorgram should be excluded from the sensorgrams used for the affinity determination.

Optionally, other reliability indicators may be used in combination with the two indicators described above. Such additional reliability indicators may relate to single curves (e.g., like the first reliability factor mentioned above) or to multiple curves (e.g., sensorgrams forming a concentration series) and may, for instance, include one or more of those listed below.

Too few curves having a signal (report point) above the noise level.

The graph signal (report point) versus concentration is not monotonous.

The difference between the highest and the lowest signal is insufficient.

The concentration series is too narrow.

Too few curves are available for analysis.

After exclusion of non-reliable batches of data sets, the “affinity model” is fitted to all accepted batches as is per se known in the art.

Preferably, the quality of the fit, the reliability of the calculated affinity and optionally other quality measures are calculated before the results of the affinity evaluation are presented to the operator.

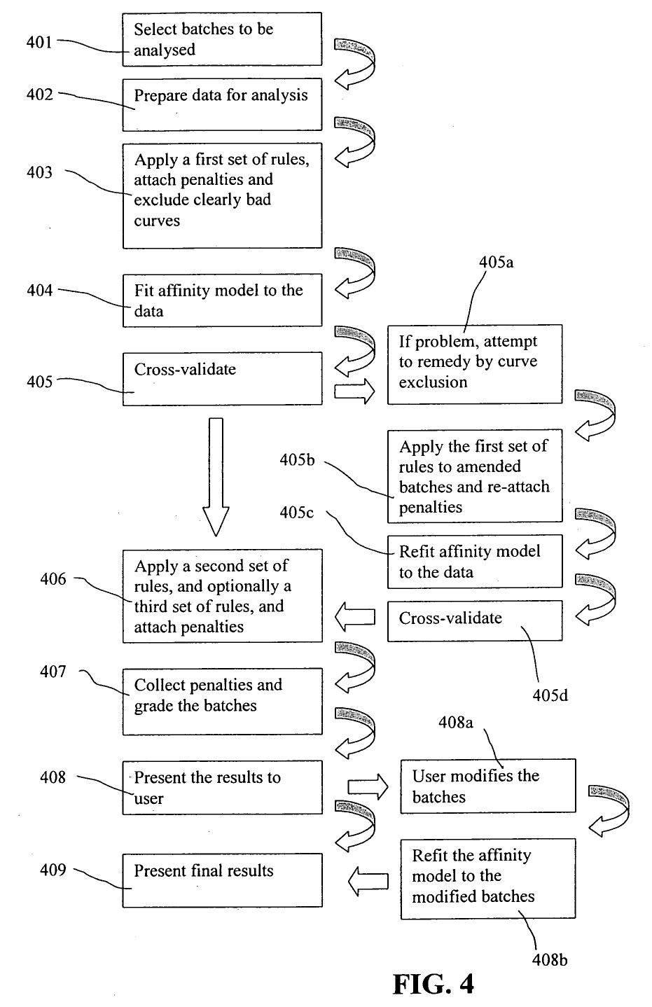

An exemplary flow chart for a software-assisted affinity evaluation is shown in FIG. 4. While believed to be generally applicable, the flow chart will be described below with regard to its use with a BIACORE® system (e.g., BIACORE® T100 system or BIACORE® A100 system). The user is assumed to have produced a fairly a large number of sensorgrams (e.g., about 300 to 2000 per 24 hours) for a plurality (e.g., about 30 to 200) of analyte-ligand interactions (as mentioned above, “ligand” here means an analyte-specific interactant immobilized to a sensor surface). For each analyte-ligand pair, a series of different analyte concentrations have been run. The sensorgrams obtained for such a concentration series is referred to below as a “batch” of sensorgrams. Optimum performance of an affinity assay has been found to be obtained for a concentration series of at least six, e.g., ten, different analyte concentrations where all concentrations reach equilibrium, the highest concentration equilibrating at Rₘₐₓ and the lowest concentration having R_{eq}<0.2*Rₘₐₓ. (Alternatively, a number of surface areas with different densities (surface concentrations) of immobilized ligand and a single analyte concentration may be used instead of a single ligand density and several different analyte concentrations.)

Prior to the affinity evaluation, it is assumed that the binding data have already been reference-subtracted, corrected for bulk effect and that a curve quality control has been run, such as, e.g., that described in the above-mentioned WO 03/081245, to automatically remove sensorgrams with spikes and nicks. Preferably also a manual general assay quality control is used where report point plots are shown to the operator for judgment of controls, carry-over, binding to reference, etc.

In a first step 401, the software presents to the user the analytes and immobilized ligands (“spots”) which have been run, and the user selects the batches of data sets, i.e., sensorgrams, to be analyzed.

In a second step 402, the software then prepares the data for analysis by, for each analyte/ligand combination, cutting out the data for the affinity analysis, the base line association phase and dissociation phase being defined by the flow rate and the event “injection stop”. The report point “binding_late” is used for the affinity determination, and sensorgram data are used for quality control.

In a third step 403, the software performs for each batch a first quality control of the prepared data for individual sensorgrams as well as for the complete batch by applying a first set of predefined “rules” based on different reliability indicators. The following two rules are particularly useful for evaluating the reliability of the steady state binding data:

(1a) Exclusion of any curve that in the association phase has a negative slope.

(1b) For each curve, an estimation of the dissociation rate and comparison with a preset limit for the injection length used, which limit may be defined as described above. This may result in exclusion of either a single curve or (usually) the whole batch, or by the attachment of a “penalty” to the batch as will be described below.

The dissociation rate is usually determined by (i) cutting out the dissociation phase, (ii) fitting the dissociation rate, and, if the fit is acceptable, (iii) determining if the dissociation rate obtained is within the preset approved range. If not, a penalty is attached to the batch containing the curve.

The first set of rules may further include:

(1c) If too few curves in a batch have a signal (report point binding_late) above the noise level, a penalty is attached to the batch.

(1d) If the graph signal (report point binding_late) is not monotonous, a penalty is attached to the batch.

(1e) If the difference between the highest and the lowest signal is insufficient, a penalty is attached to the batch.

(1f) If the concentration series is too narrow, a penalty is attached to the batch.

(1g) If too few curves are available for analysis, a penalty is attached to the batch.

For example, the following four batch penalty levels may be used:

3—forces exclusion of batch

2—forces user to inspect

1—suspicious

0—no problem detected.

Batches without penalties or with a single penalty are accepted for analysis without further action. If a batch has any penalty 3, or if the sum of all penalties for a batch is 5 or greater, the batch is automatically excluded. Batches with a sum of penalties equaling 2, 3 or 4 are marked for user inspection.

In a fourth step 404, the software fits the affinity model (e.g., the above described “1:1+Offset” model) to all accepted batches by non-linear regression as outlined above.

In a fifth step 405, a cross-validation, preferably a “leave-one out cross-validation” (see, e.g., Wold S., Technometrics, 20 (1978) 397-406), is performed to (i) find out if there are any outliers, and (ii) to obtain an estimate of the variability of the calculated parameters (chi2, standard variations).

If chi2 is significantly improved (at an approximately 99% confidence level) due to removal of one curve in a batch, it is removed in a step 405a. Only one curve may be removed from each batch. In case of more than one outlier, a penalty is attached to the batch. When a curve is removed in step 405a, the first set of rules from the third step 403 are re-evaluated in a step 405b, the affinity model is refitted to the data in a step 405c, and the cross-validation is re-calculated in a step 405d, without any resulting curve removal, however.

In a sixth step 406, a second set of rules are applied to the data resulting from step 405 or 405c, which rules may include:

(2a) If the standard deviation of the K_{D}'s calculated in the cross-validation procedure in steps 405 or 405c is too large, a penalty is attached to the batch.

(2b) If the standard deviation of the K_{D}'s calculated in the cross-validation procedure in steps 405 or 405c is large and chi2 is too large, a penalty is attached to the batch.

In step 406, also a third set of rules may be applied to test if the parameters obtained have reasonable values, which rules may include:

(3a) If Rₘₐₓ from step 404 is much larger than the highest signal in the batch, a penalty is attached to the batch.

(3b) If the Offset term from step 404 is large in comparison with the noise level and the average signal level, a penalty is attached to the batch.

In a seventh step 407, all penalties for each batch are collected and based on the same penalty criteria as described above, a batch is graded to be excluded, inspected or accepted. All batches graded to be excluded are then excluded, and the batches graded to be inspected are clearly labeled. Accepted batches are handled as accepted.

In an eighth step 408, the curve batches are presented to the user. The user may, if desired, in a step 408a modify the batches by including one or more batches that were previously excluded. The user may also include and exclude curves from a batch and change initial values for the fitting procedures. In case of such batch modification, a refit of the affinity model to the modified batches is made in a step 408b.

In a ninth step 409, the final results are presented, and the user is allowed to “finish and lock” the affinity evaluation.

The invention also extends to computer programs, particularly computer programs on or in a carrier, adapted for putting the method of the invention into practice. The carrier may be any entity or device capable of carrying the program. For example, the carrier may comprise a storage medium, such as a ROM, a CD ROM, a DVD or a semiconductor ROM, or a magnetic recording medium, for example a floppy disc or a hard disk. The carrier may also be a transmissible carrier, such as an electrical or optical signal which may be conveyed via electrical or optical cable or by radio or other means. Alternatively, the carrier may be an integrated circuit in which the program is embedded. Any medium known or developed that can store information suitable for use with a computer system may be used.

It is to be understood that the invention is not limited to the particular embodiments of the invention described above, but the scope of the invention will be established by the appended claims.

1. A method of determining affinity for a molecular binding interaction from, measured steady state binding data, which method comprises the steps of:
a) providing a plurality of experimental binding data sets for the binding interaction between two chemical species, wherein each data set includes binding data measured at multiple time points during an association phase and a dissociation phase of the interaction,
b) selecting from the plurality of experimental binding data sets a plurality of binding data measured at a defined time point at or near the end of the association phase as representing steady state binding data,
c) subjecting each data set to a quality control which comprises estimating the reliability of the steady state binding data by evaluating other binding data of the same data set,
d) excluding each data set which is estimated in step c) to contain unreliable steady state binding data, and
e) determining the affinity from the steady state binding data of remaining data sets.

2. The method according to claim 1, wherein steps c) to e) comprise the following steps:
selecting pluralities of other binding data from the plurality of experimental binding data sets;
determining which ones of the pluralities of other binding data fall within a pre-determined range, the pre-determined range representing the quality of the ones of the experimental binding data sets;
excluding from the final plurality of experimental binding data sets poor-quality experimental binding data sets, whereby the poor-quality experimental binding data sets have other binding data falling outside of the predetermined range; and
determining the affinity from the steady state binding data from the final plurality of experimental binding data sets.

3. The method according to claim 1, wherein one of the interacting chemical species is immobilized to a solid support and the other species is in solution.

4. The method according to claim 1, wherein step c) of claim 1 comprises estimating at least one predetermined reliability indicator.

5. The method according to claim 4, wherein the at least one reliability indicator comprises dissociation rate, and wherein a dissociation rate below a predetermined value indicates unreliable steady state binding data.

6. The method according to claim 5, wherein the predetermined dissociation rate value is determined from a previously established relationship between time length of the association phase and minimum dissociation rate for the interaction to substantially reach steady state.

7. The method according to claim 6, wherein the relationship between the time length of the association phase and the minimum dissociation rate for the interaction to substantially reach steady state is based on empirical interaction data.

8. The method according to claim 7, wherein the empirical interaction data comprise computer simulated interaction data.

9. The method according to claim 5, wherein the dissociation rate is estimated from dissociation phase binding data.

10. The method according to claim 4, wherein the at least one reliability indicator comprises the slope of a binding curve represented by association phase binding data, and wherein the presence of a negative slope indicates unreliable steady state binding data.

11. The method according to claim 1, wherein determining the affinity comprises fitting to a steady state affinity model.

12. The method according to claim 3, wherein the plurality of data sets comprise binding data for a number of different concentrations of the chemical species in solution.

13. The method according to claim 1, wherein step c) comprises applying a first set of predefined quality rules to the data sets to grade the data sets or batches thereof with regard to data reliability.

14. The method according to claim 13, wherein the predefined quality rules comprise at least one rule which may cause exclusion of at least one data set.

15. The method according to claim 13, wherein the quality rules comprise at least one rule which attaches a penalty to a batch of data sets.

16. The method according to claim 15, wherein a batch of data sets is excluded when the total sum of penalties exceeds a predetermined value.

17. The method according to claim 11, wherein the quality of the fit to the steady state affinity model is determined.

18. The method according to claim 17, wherein the determination of the quality of the fit comprises a cross-validation procedure.

19. The method according to claim 17, wherein, based on the determined quality of the fit, a batch of data sets is modified by exclusion of a data set thereof, the first set of predefined quality rules is re-applied to the modified batch, and the steady state affinity model is refitted to the batch.

20. The method according to claim 17, wherein a second set of quality rules is applied to the affinity determined in step e) of claim 1.

21. The method according to claim 20, wherein the second set of quality rules comprises at least one rule which attaches a penalty to a batch of data sets.

22. The method according to claim 21, wherein a batch is excluded when the total sum of penalties exceeds a predetermined value, and the steady state affinity model is refitted to the batch.

23. The method according to claim 1, wherein the experimental binding data are determined by a biosensor.

24. The method according to claim 23, wherein the biosensor is based on surface plasmon resonance (SPR).

25. The method according to claim 1, wherein the method is computer-implemented.

26. An analytical system for detecting molecular binding interactions, comprising:
(i) a sensor device comprising at least one sensing surface, detection means for detecting molecular binding interactions at the at least one sensing surface, and means for producing detection data representing binding curves, wherein each curve represents the progress of a binding interaction with time, and
(ii) data processing means for performing steps a) to e) of claim 1.

27. A computer program comprising program code means for performing the affinity determination of claim 1 when the program is run on a computer.

28. A computer program product comprising program code means stored on a computer readable medium or carried on an electrical or optical signal for performing the affinity determination of claim 1 when the program is run on a computer.

29. A computer system containing a program for performing the affinity determination of claim 1.

30. A method of affinity analysis, which comprises:
providing a data set comprising data for the binding interaction between two chemical species, which data represent a binding curve for the interaction,
selecting data from a first domain of the binding curve for determining the affinity of the interaction, and
selecting data from a second domain of the binding curve to estimate the reliability of the data from the first domain, and
when the data from the first domain is estimated to be reliable, using the data for determining the affinity of the binding interaction.

31. A method of determining affinity for a molecular binding interaction between a first chemical species and a second chemical species, which method comprises:
providing a solid support surface having the second species immobilized thereto,
contacting a fluid containing the first species with the solid support surface for a predetermined contact time,
determining association of the first species to the surface to provide association data,
contacting the solid support surface with fluid free from the first species and determining dissociation from the surface to provide dissociation data,
based on a predetermined relationship between contact time and minimum dissociation rate for equilibrium, estimating from the dissociation data if equilibrium for the interaction has substantially been reached during the predetermined contact time, and
if equilibrium has substantially been reached, using association data for determining an affinity value for the interaction.
